(19) United States
(12) Patent Application Publication
(10) Pub. No.: US 2003/0165605 A1
(43) Pub. Date: Sep. 4, 2003

(54) Frozen dough and baked products

(76) Inventors: Jackie Brown, Williamsville, NY (US); Thomas J. Aurand, Orchard Park, NY (US); Dave Zhang, Depew, NY (US)

Correspondence Address: KENYON & KENYON, 1500 K STREET, N.W., SUITE 700, WASHINGTON, DC, 20005, US

(21) Appl. No.: 10/353,979

(22) Filed: Jan. 30, 2003

Related U.S. Application Data
(60) Provisional application No. 60/352,499, filed on Jan. 31, 2002.

(51) Int. Cl. A21D 10/00

(52) U.S. Cl. 426/549

(57) ABSTRACT

A non-laminated, non-pre-proofed frozen dough has been prepared that can go directly from the freezer to the oven to produce a high quality baked product in a short period of time. Flour, water, yeast and dough conditioner are mixed to form dough. The dough is preferably rested for about 10 or more then frozen. The frozen dough can then be thawed, proofed, and baked, preferably in a multi-phase oven. The dough preferably has a specific volume of less than 1.5 and preferably yields a baked product having a specific volume of about 4 cc/g or more.

### CROSS-REFERENCE TO RELATED APPLICATION

This application claims the benefit of U.S. Provisional Application No. 60/352,499, filed Jan. 31, 2002.

### FIELD OF THE INVENTION

The present invention relates to frozen dough that is not substantially pre-proofed. The frozen dough may be placed directly in an oven for thawing, proofing and baking.

### BACKGROUND OF THE INVENTION

Yeast-leavened dough products known in the art generally required “proofing” prior to baking. “Proofing” is the time required for yeast in a dough to produce sufficient amount of carbon dioxide gas to give correct height, volume, and structure in a baked product. Proofing may be carried out to some extent prior to freezing, such as by a dough manufacturer, and/or after freezing, such as by a retailer.

In one frozen dough system, the dough is not proofed prior to freezing. However, in this method the dough must undergo a thawing procedure and proofing steps which usually require two to sixteen hours for thawing, depending on the method, and an additional one to two hours time for proofing. This is inconvenient because the dough should be removed from the freezer at least three hours before baking and cannot be used “instantaneously”.

In another frozen dough system, dough is proofed before freezing; that is, the dough is “pre-proofed”. However, one drawback with this procedure is the time requirement needed to proof the dough prior to freezing. Second, pre-proofed dough is susceptible to tearing, which can cause the loss of entrapped gas. Third, frozen storage stability of this dough is reduced since the yeast is in an active growth phase when frozen, and therefore does not remain viable. Fourth, pre-proofed dough tends to take up more space than non-pre-proofed dough when being stored or transferred. Fifth, pre-proofed frozen doughs tend to thaw faster because they are less dense than non-pre-proofed doughs; the quality of the product could be diminished if it is thawed or partially thawed prior to baking, such as when the frozen product is being transferred. Sixth, pre-proofed dough often calls for expensive ingredients, such as high amounts of protein.

Some methods use a chemical leavening agent in place of yeast, which obviates the need for proofing. However, chemical leavening agents tend to detract from the texture, flavor, and structure associated with proofed dough products. An illustrative example is provided by a comparison of a biscuit or Irish soda bread (chemically leavened; unproofed) with a bread loaf, a dinner roll, or a bread stick (yeast leavened; proofed). Proofed products are generally lighter, less dense, less chewy, more porous, more aerated than chemically leavened unproofed products.

### SUMMARY OF THE INVENTION

One embodiment of the invention is a non-laminated frozen dough comprising flour, water, yeast, and dough conditioner. The dough preferably contains less than 16% protein. The dough is rested, preferably for about 10 minutes or more, before being frozen. The dough has a specific volume of less than 1.5 before being frozen, yet is capable of achieving an industry-acceptable baked specific volume.

Another embodiment of the invention is a method of making a non-laminated frozen dough comprising mixing ingredients including flour, water, yeast and dough conditioners to form a dough, resting the dough, preferably for about 10 minutes or more; and freezing the dough.

Another embodiment of the invention is a method of making a baked product comprising thawing non-laminated frozen dough at a first temperature and humidity for a time sufficient to thaw the dough, proofing the dough at a second temperature and second humidity sufficient to proof the dough, and baking the dough at a third temperature sufficient to bake the dough.

### DETAILED DESCRIPTION

The present invention will now be described in detail for specific preferred embodiments of the invention, it being understood that these embodiments are intended only as illustrative examples and the invention is not to be limited thereto.

Frozen Dough

The present invention relates to frozen dough that does not require proofing prior to freezing. The dough of the invention includes flour, water, yeast and one or more dough conditioners.

The dough of the present invention is also not substantially pre-proofed prior to being frozen. “Not substantially pre-proofed” is intended to mean that minimal leavening occurs prior to freezing. The frozen dough has a specific volume of less than about 1.5 cc/g, preferably about 1.0 to about 1.5 cc/g, more preferably about 1.2 cc/g to about 1.5 cc/g, more preferably about 1.3 cc/g to about 1.5 cc/g, at the time it is frozen.

Preferably, the frozen dough of the present invention includes the following ingredients:

| Ingredient | | | | |
|---|---|---|---|---|
| Preferred | | | | |
| more preferred | Crusty Roll or | | | |
| more preferred | Bread | Pretzel | Pizza | Soft Roll |
| Flour | 100 | 100 | 100 | 100 |
| | 100 | 100 | 100 | 100 |
| | 100 | 100 | 100 | 100 |
| Water | 45-80 | 45-80 | 45-80 | 45-80 |
| | 50-65 | 50-70 | 50-70 | 50-70 |
| | 55-60 | 55-65 | 55-65 | 55-65 |
| Yeast | 0.4-8 | 0.4-8 | 0.4-8 | 0.4-8 |
| | 1-4 | 1-4 | 1-4 | 1-4 |
| | 1.5-3.5 | 1.5-3.5 | 1.5-3.5 | 1.5-3.5 |
| dough conditioner | 0.1-10 | 0.1-10 | 0.1-10 | 0.1-10 |
| | 0.5-8 | 0.5-8 | 0.5-8 | 0.5-8 |
| | 1-3 | 1-3 | 1-3 | 1-4 |
| protein (including | 11-20 | 11-20 | 11-20 | 11-20 |
| the gluten in the | 12-16 | 12-16 | 12-16 | 12-16 |
| flour) | 13-15 | 13-15 | 13-15 | 13-15 |
| Salt | 0-5 | 0-5 | 0-5 | 0-5 |
| | 1-3 | 0-3 | 1-3 | 1-3 |
| | 2 | 0-1 | 2 | 2 |

Each of the preceding amounts is approximate percentages by weight of flour having approximately 12% by weight gluten. The invention, however, is not limited to the use of flour containing 12% gluten. Flour containing other amounts of gluten could be used. For example, high-gluten flour typically contains about 11-12% gluten; bread flour typically contains about 10-11% gluten; pastry flour typically contains about 8-9% gluten; and cake flour typically contains about 7-8% gluten. One of ordinary skill in the art would appreciate that the preferred amounts of the various ingredients might change slightly based on the type of flour used. Moreover, gluten may be added to the flour.

The flour of the present invention may include one or more types of flour. Non-limiting examples of flours that may be included in the flour of the present invention include for example, bread flour, high gluten flour, wheat flour, barley flour, soy flour, malt flour, rye flour, corn flour, potato flour and pastry flour, and combinations and mixtures thereof.

Preferably, the flour of the present invention includes enriched flour, i.e., flour that contains federally mandated amounts of flour, niacin, ferrous sulfate, riboflavin, enzyrne, and thiamine mononitrate folate. Other types of flours may be substituted for the enriched flour or used in combination with enriched flour.

The flour used in accordance with the present invention preferably includes high gluten flour. Typically, “high gluten” flour contains greater than 10% protein. Protein levels can fluctuate from product to product or season to season. High-protein doughs, such as high-gluten dough, generally promote the strength of the dough and tend to increase shelf life.

In a preferred embodiment, the frozen dough contains less than 16% protein by weight of the flour. Although gluten is a common type of protein, other types of protein can be used in accordance with the invention. For example, dairy proteins, such as dairy whey, could be used.

Sufficient water may be added to the present doughs to achieve the desired consistency. The precise amount of water depends on several factors known to those skilled in the art, including the type of yeast included, the desired final product, and the amount and type of other ingredients. Water is typically added in an amount of about 45% to about 80%, as compared to the amount of flour.

The leavening agent in the dough is preferably yeast only. The invention does not exclude, however, possible supplementation with chemical leaveners. The yeast included in the dough may be any type of suitable yeast known to those skilled in the art. Yeast can be purchased and used in different forms. The driest commonly used yeast, sometimes referred to as “instant” yeast, contains 3.5-6% water. Other types of yeast, which generally contain increasingly more water content, include active dry yeast, compressed yeast and cream yeast. Other examples include baker's yeast, protected active dry yeast, frozen yeast and the like. Unless otherwise stated, as used herein, quantities of “yeast” refer to quantities of instant yeast and equivalent quantities of hydrated forms of yeast. By referring to instant yeast, it makes quantitation of the yeast easier. However, the invention is in no way limited to instant yeast; one of ordinary skill in the art could easily determine the equivalent amount of a greater or lesser hydrated form of yeast that contains the same amount of yeast as a given quantity of instant yeast. For example, 1 lb. compressed yeast is equivalent to about 0.3125-4 lbs. instant yeast. Generally, 1% compressed yeast is equivalent to about 1.5-1.8% cream yeast, which is equivalent to about 0.375-0.5% active dry, which is equivalent to about 0.3125-0.4% instant yeast. Cream yeast contains about 80-85% moisture; compressed yeast contains about 66-73% moisture; active dry yeast contains about 6-8% moisture; and instant yeast contains about 3.5-6% moisture.

The amount of yeast may be chosen to correspond to the desired density of the final baked product and the flavor profile. The yeast amount tends to affect the useable life of the dough; generally, using more yeast tends to increase the dough life.

For a given application, the optimal amount of cream yeast, for example, will be higher than the optimal amount of dry activated yeast because cream yeast contains a greater amount of water. Cream yeast typically contains about 15-20% yeast.

The term “dough conditioner” is intended to include one or more dough conditioners or combinations thereof. Dough conditioners that may be used in accordance with the present invention include dough conditioners known to those in the art. Examples of suitable dough conditioners include, for example, one or more of the following types of ingredients: dough strengtheners, such as DATEM (diacetly tartaric acid esters of mono- and diglycerides), oxidizing agents such as potassium iodate, azodicarbonamide, potassium bromate, and ascorbic acid, surfactants such as SSL (sodium stearoyl lactylate), CSL (calcium stearoyl lactylate), lecithin and mono- and diglycerides, mix time reducers, such as L-cysteine, and the like, or combinations thereof. In particular, examples of manufactured dough conditioners on the market, which may be used in accordance with the present invention include, for example ULDO OPTIFROST (DATEM, wheat gluten, sugar, dextrose, wheat flour, guar gum, active malt flour, calcium, pyrophosphate, lecithin, ascorbic acid, enzyme), sold by BAKE 'N JOY™, ES 45 PPG (DATEM, ascorbic acid, enzymes) sold by SAF PRODUCTS, PANIPAN SPRINT (wheat gluten, emulsifier, soya flour, dextrose, malt flour, antioxidants, thickener, enzymes), sold by LASEM ALIMENTACION, and QUICK STEP (wheat flour, guar gum, DATEM, dextrose, mono and diglycerides, soy oil, ascorbic acid, enzymes), sold by PURATOS. Preferably, the dough conditioner of the present invention includes one or more of ascorbic acid, DATEM, and mon- and diglycerides. The amount and type of dough conditioners used in accordance with the present invention varies depending on various factors, including the other ingredients in the dough and the type of dough and desired final baked product, as would be apparent to those skilled in the art in view of the present application.

In addition to flour, water, yeast and dough conditioner, the frozen dough of the present invention may further include one or more additional ingredients including, for example, gluten, salt, iron (preferably in the form of ferrous sulfate), glutathione, calcium sulfate, ammonium sulfate, monocalcium phosphate, stabilizers, flavored oils, enzymes (in addition to any enzymes included in the dough conditioners), sugar, deactivated yeast, niacin, one or more fat sources, riboflavin, vitamins, minerals, oil, corn meal, thiamine mononitrate, at least one flavoring, coloring agents, and the like, or combinations thereof. Particularly preferred ingredients include gluten, enzymes and salt.

Non-limiting examples of stabilizers according to the present invention include, for example, guar gum, locust bean gum and xanthan gum.

Enzymes according to the present invention may include, for example, fungal amylase, hemicellulase, and glucose oxidase. The amount and type of enzyme of the present invention may be determined by those skilled in the art depending on the specific desired resulting properties.

Sugars according to the present invention may be selected in type and amount depending for example on the desired properties and flavor of the dough, or may be used for example, as a ready “food” supply for the yeast to feed on before feeding on the starches and protein structure. Fine granulated sugar is preferred, although other sugars or combinations of sugars known to those skilled in the art, may also be used.

Salt, preferably a fine-blending salt, may be added, for example, to promote better mixing, to enhance flavoring, to control moisture content within the dough, and/or to control yeast activity. Fine-blending salt is readily available on the market, as for example, from Cargill, Incorporated.

The dough of the invention may include an effective amount of one or more fat sources. The fat source contributes flavor and texture to the baked goods and may be solid or plastic, as well as liquid or semi-fluid. One example of a suitable fat source according to the present invention includes shortening. Shortening is an emulsified oil or higher melting fat which is suitable for use in baked products. Glyceride shortenings derived from animal or vegetable fats and oils including synthetically prepared shortenings are suitable for use herein. The glyceride may contain saturated or unsaturated long chain acyl radicals having from about 12 to about 22 carbon atoms generally obtained from edible oils and fats such as corn oil, cottonseed oil, soybean oil, coconut oil, rapeseed oil, peanut oil, olive oil, palm oil, palm kernel oil, sunflower seed oil, wall flower oil, lard, tallow and the like. Examples of preferred shortenings according to the present invention, include vegetable shortenings, soybean based shortenings or oils, hydrogenated soybean-based shortening or oil, corn oil, palm oil, hydrogenated palm oil, lard and tallow oils. Butter and/or margarine may also be suitable as a shortening.

Hydrogenated shortening is preferably used if a slight crispiness to the outside of the cooked dough is desired. The hydrogenated shortening provides better crust definition and crispiness. Hydrogenated shortening suitable for use with the invention is readily available on the market, as for example the SHO-2 product from Central Soya. Vegetable shortening that may be used in accordance with the present invention is preferably in the form of shortening flakes.

The amount and type of fat source may be selected by those skilled in the art based on various factors including the ingredients of the frozen dough, and based on the desired taste and physical characteristics, such as maintaining a consistent internal structure.

Any oil can be used, according to embodiments of the invention, but vegetable oil is preferred in certain embodiments of the invention, due to its taste and lubrication properties. Examples of vegetable oils that may be used in accordance with the present invention, include, but are not limited to, soybean oil, cottonseed oil, peanut oil, canola oil, corn oil, olive oil and sunflower oil. Soybean and/or cottonseed oils are preferred. Certain oils, including sunflower and corn oils, potentially adversely affect the overall flavor profile of the dough and are therefore, less preferred.

Flavored oils may also be used in addition to or in place of the oil of the present invention. Non-limiting examples of flavored oils include olive, sesame, ginger and the like.

Flavorings according to the present invention may include, for example, oregano, basil, garlic, pepper, honey, sesame, cheese, cinnamon, wheat oats, peppers, onions, salsa based flavors, and tomatoes. Additionally, to achieve a desired flavor profile, a spray-dried encapsulated flavoring agent may be added to the dough. Spray-dried encapsulated flavorings are readily available on the market. Many different flavors can be used to achieve a desired effect, for example, yeast flavors. Examples of doughs containing a flavoring include an onion roll dough, which may contain for example 0.05% spice blend, and challah bread, which may contain for example 0.1% beta-carotene. Sweet doughs may contain for example 1% of flavoring agents and/or coloring agents.

When using flavorings, the amount of water and salt used in the dough may have to be adjusted to take into account, for example, the amount of salt and water already contained in the flavoring. It is believed that “fine tuning” of the amount of salt and water in the dough would be within the ability of one of ordinary skill in the art.

One or more coloring agents, such as dyes, can be used to produce and/or enhance the desired color of the dough. The coloring agent may be natural and/or artificial. If a coloring agent is used, the coloring agent is preferably less than about 0.5% of the dough and more preferably about 0.01% of the dough. Examples of suitable coloring agents would be known to those skilled in the art.

Yeast foods include for example, ammonium sulfate.

Vitamins and minerals that may be added to the doughs of the present invention would be apparent to those skilled in the art. A non-limiting example of suitable vitamins and minerals according to the present invention is riboflavin.

The dough of the invention does not require the presence of either melting point depressants or fermentation aids, as those terms are known to those skilled in the art. Melting point depressants, such as ethanol, are generally used to soften the dough and to help overcome thaw lag when baking dough from a frozen state. Fermentation aids are typically fermented mixtures of flour, sugar, water and yeast whose purpose is to reduce fermentation time. Since neither are required for the invention, preferably they are not present.

Other ingredients known to those skilled in the art may optionally be added to the dough, filled in the dough, or topped over the dough of the invention to achieve a baked product having the desired texture, flavor and other desired properties, depending on the desired final baked product.

Preparation of Frozen Dough

In one aspect of the invention, frozen dough is prepared by mixing ingredients comprising flour, water, yeast and dough conditioner to form dough; resting the dough, preferably for about 10 minutes or more; and freezing the dough. The dough is not substantially proofed before freezing.

Mixing may include either mixing all of the ingredients at once or mixing different combinations of ingredients first and then mixing all of the ingredients together. For example, according to at least one embodiment, certain of the ingredients are combined to form a pre-mix, including for example, the optional salt, stabilizers and sugar. Then, the pre-mix is mixed with the remaining ingredients including the flour, yeast, and water. The pre-mix and/or the final mixture may include one or more additional ingredients as set forth herein.

The ingredients are mixed with one another to form a dough by mixing methods and under mixing conditions generally known in the art. The ingredients are mixed by any suitable mixing apparatus, such as a Hobart mixer. Preferably, the ingredients are mixed for about 12 minutes on medium speed.

After mixing, the dough is preferably at a temperature of about 55° F. to about 80° F., more preferably about 60° F. to about 75° F., more preferably about 62° F. to about 65° F. The dough can then optionally be divided, rounded, molded or otherwise manipulated. After manipulating the dough as desired, the dough is rested, preferably at ambient temperatures, preferably for about 10 minutes or more, more preferably for about 10 to about 60 minutes, more preferably about 15 to about 30 minutes, even more preferably about 20 minutes, preferably immediately before freezing.

“Resting” denotes periods of time allowed to give the dough sufficient time to recover from any step such as mixing, dividing, molding, forming and the like, particularly when the dough has been stretched or worked. Preferred embodiments of the dough are rested for about 10 minutes or more, more preferably about 10 to about 60 minutes, more preferably about 15 to about 30 minutes, at ambient temperatures before being frozen. However, as one skilled in the art would appreciate, the preferred resting time will vary somewhat based on the particular dough composition and the temperature at which the dough is rested. Typically, higher-than-ambient temperatures require somewhat shorter resting times.

It is believed that the resting period permits the wheat protein in the dough to be realigned forming a more elastic matrix prior to the initiation of yeast growth. The elastic matrix is able to entrap more of the CO₂ produced during yeast growth. If the resting period is too short, a low baked volume tends to result. If the temperature is too high or resting is too long, yeast will tend to enter a rapid growth phase, thereby resulting in proofing.

The temperatures and resting periods may be adjusted outside the above ranges, so long as the resulting dough is a dough that does not need a pre-proofing step, and may be placed directly into an oven after freezing for thawing, proofing and baking with satisfactory results. For example, the dough may be formulated at a cooler temperature than 55° F., such as about 40° F. to about 55° F., but have a longer resting time than 30 minutes, such as 30-40 minutes, and still be a dough according to the present invention. If the dough temperature is much higher, for example around 80° F., the resulting finished product may lose baked volume. Adjustment of the temperature and resting time may be performed by those skilled in the art in view of the present disclosure.

Frozen dough according to the present invention is frozen by methods known in the art. If the dough is going to be frozen for a short period of time, the mode of freezing is not critical. However, for prolonged stability, the dough should be frozen such that core temperatures of less than −21° C. and preferably between about −21° C. and about −31° C. are obtained within 15 minutes to 6 hours and more preferably within about 1½ to about 4 hours of the time that the dough is placed in the freezing apparatus. When freezing the dough, a uniform cooling rate throughout the dough is desirable.

For prolonged stability, the frozen dough is preferably stored at a temperature in a range of from about −41° C. to about −12° C., more preferably at a temperature in the range of from about −29° C. to about −11° C. Frozen dough according to preferred embodiments of the invention may be stored for at least three months, even more preferably, at least four months. Frozen dough stability is the ability of the dough to substantially maintain finished bread quality performance characteristics throughout the frozen storage of the dough product. Quality parameters include, for example, baked specific volume, crumb characteristics, and surface drying.

A preferred embodiment of the dough is able to maintain desirable properties such as flavor, texture, stability, and the like, throughout frozen storage. When the frozen dough of the present invention is to be stored frozen for a substantial period of time, it is optionally wrapped in a moisture barrier. The wrapping may occur either before or after freezing.

Optionally, the dough may be topped with toppings and/or flavorings before and/or after freezing. Examples of doughs that may be topped, include pizza dough, breadstick dough, bagel dough and the like. Also included within the present invention is topped frozen dough, which has another layer of dough over the topping, such as in the case of pizza pockets, stuffed pizzas, calzones, and the like.

Non-limiting examples of suitable toppings according to the present invention include, for example, sauces, cheeses, vegetables, flavorings, meats and mixtures thereof. Specific non-limiting examples of toppings according to the present invention include tomato sauce, pesto, mozzarella cheese, pepperoni, sausage, ham, olives, mushrooms, peppers, pineapple, onions, tomatoes, sesame seeds, poppy seeds, sun dried tomatoes, salt, and the like, and combinations thereof, as would be apparent to those skilled in the art.

Non-limiting examples of flavorings that may be used as toppings include for example, oregano, basil, garlic, pepper, honey, sesame, cheese, cinnamon, wheat oats, peppers, onions, sugar, salsa based flavors, tomatoes, and the like. In the case of sweet breads or soft pretzels for example, optional toppings include for example, candies, sugar, powdered sugar, frostings and the like.

The dough is optionally filled with at least one filling by methods known in the art (such as by injection) before freezing or alternatively filled after removing the frozen dough from a freezer, for example in the case of calzones, cinnamon logs and the like.

The dough may be shaped prior to being frozen, such as, into the form of traditional or untraditional shaped rolls, bagels, pizza crusts (e.g., round or square), breadsticks, pretzels (conventional shape, sticks, rounds, bites or any other shape). For example, in the case of forming pizza dough, shaping preferably includes sheeting the dough and then cutting the dough into the form of a substantially round pizza.

Preparation of Baked Products

According to one embodiment of the invention, a method for preparing a baked product comprises thawing non-laminated frozen dough at a first temperature and humidity sufficient to thaw the dough; proofing the dough at a second temperature and second humidity sufficient to proof the dough; and baking the dough at a third temperature sufficient to bake the dough. Additional temperature phases may be included in the thawing, proofing, and/or baking steps, depending on the rate of thawing, type of dough being baked, etc.

During the thawing and proofing stages, the humidity of the chamber is preferably controlled to provide an environment that will result in desired finished product characteristics. Therefore, a first, second, third and optionally additional humidity phases may be included in the present methods as well. One or more of the humidity phases may be the same or different from one another. The first, second, third and optionally additional temperatures may be the same or different. Pretzels and pizza dough, for example, may proofed and baked at a single temperature.

According to at least one preferred embodiment, temperatures in the thawing and proofing stages can range from about 104° F. to about 400° F. To maintain an appropriate humidity in an oven, water is injected periodically into the oven for a total of 0 to about 3.5 mL water/L oven capacity. Ovens according to these embodiments may include, for example, a steam injected convection oven. A method in which the humidity may be removed is by rapidly blowing the water-laden air out of the chamber without substantially reducing the temperature of the oven chamber.

In a preferred embodiment where the humidity is elevated during a thawing step, a skilled artisan would appreciate that if the temperature is sufficiently increased during a proofing step, for example, the humidity tends to dissipate. In a preferred embodiment, water that is added to the oven, if any, is done periodically during the thawing step and then allowed to dissipate during subsequent heating steps.

According to these embodiments, the multiple baking phases including temperature and/or humidity control may be automatic as in the case of a pre-programmable oven, or may be done manually. Preferably, the oven is a programmable, multiple-phase oven, such as those made by MiWe or Wiesheu. A multiple-phase oven that is able to control temperature and/or humidity conditions may be preprogrammed to automatically change temperature and/or humidity in the oven. The oven is preferably pre-programmed to change temperature from a first temperature sufficient for thawing the dough, to a second temperature sufficient for proofing the dough, to a third temperature sufficient for baking the dough after the dough is sufficiently thawed and proofed (which may be measured in one or more ways including, for example, time, volume, temperature, etc.). Additional temperature changes may be programmed ahead of time or set as the baking progresses, depending on the progress of the dough in thawing, proofing and baking. Also, the programmable oven preferably also programs the humidity of the oven to be a suitable humidity at various stages in the thawing, proofing and baking process.

Alternatively, the oven temperature and/or humidity is manually changed from one temperature or humidity level to the next, or the dough is transferred from one oven to the next, depending on the desired conditions.

According to other embodiments, frozen dough can be removed from a freezer and, without substantially thawing or proofing the dough, transferring the dough to an oven set to a first temperature sufficient to thaw the dough, and then either maintaining or changing the temperature to proof the dough or transferring the dough to a second oven set at a second temperature to proof the dough; and transferring the dough to a third oven at a third temperature sufficient to bake the dough, resulting in a baked product.

Preferred embodiments of the invention comprise putting frozen dough in an oven without using a retarder or a proofer. Such additional steps may increase the time and/or expense of preparing a baked product. Moreover, the use of a proofer may lead to a lack of consistency in producing a high quality product. Embodiments of the invention may include the use of retarders or proofers, but such machines are not required.

Preferred baked-product embodiments of the invention preferably have a specific volume that is generally known in the industry as acceptable for that particular product. For example, for breadsticks, the industry-accepted baked specific volume is generally about 3.0-3.5 cc/g; for pretzels, it is generally about 2.0-3.5 cc/g. For most other products, such as rolls, the industry-accepted minimum specific volume is generally 3.5 cc/g or more, preferably about 4.0 cc/g or more.

In a preferred embodiment, an oven is used that produces a high humidity atmosphere and provides a low temperature profile to permit thawing and proofing. The oven is preferably pre-heated to a first temperature sufficient to thaw the dough. The thawing temperature is preferably from about 104° F. to about 400° F., preferably about 113° F. to about 375° F., even more preferably about 140° F. to about 360° F., which typically thaws the dough in about 5 to about 50 minutes, preferably about 7 to about 40 minutes, more preferably about 9-30 minutes, depending on various factors, such as the temperature, dough ingredients and shape.

The proofing temperature is preferably about 200° F. to about 450° F., even more preferably about 300° F. to about 400° F., which preferably proofs the dough in about 20 to about 30 minutes, preferably about 15 to about 25 minutes, even more preferably about 3 to about 20 minutes, depending various factors such as the temperature, dough ingredients and shape.

The baking temperature is preferably about 250° F. to about 5000 F, even more preferably about 325° F. to about 480° F., which bakes the dough into a baked product after about 2 to about 50 minutes, preferably about 3 to about 30 minutes, even more preferably about 4 to about 20 minutes, depending various factors such as the temperature, dough ingredients and shape. A yeast-leavened baked product is typically considered fully baked when its interior reaches a temperature of at least about 167° F., preferably about 176° F.

The temperatures provided above, particularly for proofing and baking, reflect preferred final temperatures. The skilled artisan would appreciate that in a preferred embodiment using a single oven, some of the time allocated for each of these steps would include the time it takes for the oven to change from one temperature to another temperature.

The preferred conditions for thawing, proofing and baking conditions vary based on the type of baked product that is being prepared. By way of example, the following product-specific conditions are preferred.

| | | | | | | | Humidity |
|---|---|---|---|---|---|---|---|
| | | Thaw | Proof | Bake | | | (mL |
| | Rest | Time/ | Time/ | Time/ | | Baked | water/L |
| Product | Time | Temp | Temp | Temp | Frozen | S.V. | oven |
| Type | (min) | (min/F.) | (min/F.) | (min/F.) | S.V. (cc/g) | (cc/g) | capacity) |
| Pretzel | 10-60 | 9-30 | 4-20 | | 1.0-1.5 | 2.0-3.5 | 0.4-3.5 |
| pref. | | 140-360 | 325-480 | | | | |
| more | 10-20 | 10-18 | 5-15 | | 1.2-1.5 | | 1.1-2.3 |
| pref. | | 225-325 | 350-480 | | | | |
| more | 10 | 10 | 7 | | | | 1.6-2.3 |
| pref. | | 300 | 480 | | | | |
| Pizza | 10-60 | 9-30 | 4-20 | | 1.0-1.5 | 3.5-4.5 | 0.4-3.5 |
| pref. | | 140-360 | 325-480 | | | | |
| more | 10-30 | 9-15 | 5-15 | | 1.2-1.5 | | 0.4-2.3 |
| pref. | | 325-360 | 350-450 | | | | |
| more | 30 | 9 | 6 | | | | 1.1-2.3 |
| pref. | | 356 | 383 | | | | |
| Soft | 10-60 | 9-30 | 3-20 | 4-20 | 1.0-1.5 | 4.0-6.0 | 0.4-3.5 |
| Roll | | 140-360 | 300-400 | 325-480 | | | |
| pref. | | | | | | | |
| more | 10-30 | 10-20 | 5-15 | 4-15 | 1.2-1.5 | 4.5-6.0 | 0.4-2.3 |
| pref. | | 200-300 | 300-375 | 325-375 | | | |
| more | 20 | 13 | 8 | 5 | | | 1.1-2.3 |
| pref. | | 250 | 350 | 375 | | | |
| Crusty | 10-30 | 10-30 | 3-20 | 5-20 | 1.0-1.5 | 4.0-6.0 | 0.4-3.5 |
| Roll | | 140-360 | 300-400 | 325-400 | | | |
| pref. | | | | | | | |
| more | 15-25 | | | | 1.2-1.5 | 4.5-6.0 | 0.4-2.3 |
| pref. | | | | | | | |
| more | 20 | | | | | | 1.1-2.3 |
| pref. | | | | | | | |
| Bread | 10-60 | 9-30 | 3-20 | 4-20 | 1.0-1.5 | 4.0-6.0 | 0.4-3.5 |
| pref. | | 140-360 | 300-400 | 325-480 | | | |
| more | 10-30 | 9-15 | 10-20 | 8-15 | 1.2-1.5 | 4.5-6.0 | 1.1-2.3 |
| pref. | | 175-360 | 300-400 | 325-400 | | | |
| more | 30 | 12 | 14 | 11 | | | 1.6-2.3 |
| pref. | | 275 | 400 | 350 | | | |

The exact conditions under which the dough is baked will depend upon the type and shape of the product being formed and ingredients of the dough, as will be apparent to one skilled in the art. For example, shapes having greater surface-to-volume ratios will cook faster than shapes having lesser surface-to-volume ratios.

Preferred baked products according to the present invention, include for example, breads (including crusty and soft), rolls (including crusty and soft), sweet goods (such as cinnamon or other flavored buns, logs, rolls and the like), pizza products (such as pizza crusts, pizza pockets, stuffed pizzas, calzones and the like), breadsticks, soft pretzels, bagels, and the like. Preferably, the baked products of the present invention are substantially similar in appearance, texture, structure, taste, and aroma to baked products prepared by methods that include a pre-proofing step.

The present invention will now be described in detail with respect to showing how certain specific representative embodiments thereof may be made, apparatus and process steps being understood as examples that are intended to be illustrative only. In particular, the invention is not intended to be limited to the methods, ingredients, conditions, process parameters, apparatus and the like specifically recited herein.

### EXAMPLES

### Example 1

### Frozen Dough For Crusty Roll

Dough was prepared from the following ingredients:

| INGREDIENT | Flour % |
|---|---|
| HG Flour (12% gluten) | 100% |
| Water | 57.5% |
| Cream Yeast | 9.5% |
| Dough conditioners | 2.2% |
| (Lasem Panipan Sprint) | (2%) |
| (Ascorbic Acid) | (0.2%) |
| Gluten | 2% |
| Salt | 2% |

Dough is made having the above ingredients, using the following procedure:

1. All of the ingredients were mixed at a temperature of about 64° F.

2. The dough was divided, rounded, molded and then rested for about 20 minutes at ambient temperature.

3. The dough was then frozen and had a specific volume of about 1.35 cc/g.

### Example 2

### Preparation of Crusty Roll

A crusty roll was prepared according to the following method:

1. The frozen dough of Example 1, was placed directly into a programmable oven without first thawing the dough. The programmable oven was a moisture-injected oven (MiWe DS Aeromat, model 97450) where the program can control temperature, water injection and chamber air circulation. The oven, which has an oven capacity of about 430 L, was injected with 0.5 liters water, which was sprayed essentially equally throughout the thaw phase, and the temperature profile was set to permit thawing. In particular, the programmable oven was pre-heated to about 280° F., and the dough was thawed in the oven for about 12 minutes.

2. The programmable oven settings then automatically changed after thawing to permit proofing. The temperature was reset to about 400° F. The humidity was allowed to. dissipate, not released. The dough was proofed for about 10 minutes, including the couple minutes it took for the oven temperature to reach 400° F.

3. The temperature was reset to about 355° F. and the roll was baked for about 11 minutes, producing a ready-to-eat baked product having a specific volume of about 4.5 cc/g.

In Examples 3-6, each respective dough contained the following ingredients:

| Ingredient (based | Example 3 | Example 4 | Example 5 | Example 6 |
|---|---|---|---|---|
| on % flour) | (pretzel) | (pizza) | (soft roll) | (bread) |
| Flour (12% gluten) | 100 | 100 | 100 | 100 |
| Water | 51 | 61 | 56 | 61.2 |
| Yeast (compressed) | 6.0 | 6.0 | 10.0 | 6.0 |
| Conditioner | | | | |
| Lasem | 2.0 | 2.0 | | 2.0 |
| Puratos Quick | | | 3.0 | |
| Step | | combination | | combination |
| Ascorbic Acid | | ascorbic acid | | ascorbic |
| Enzymes | | and enzymes | 0.006 | acid and |
| Hemicellulase | | @ 0.2% | 0.003 | enzymes @ |
| Amylase | | | 0.012 | 0.2% |
| Glucose oxidase | | | 0.006 | |
| Amyloglucosidase | | | | |
| Gluten | | 2.0 | 2.0 | 2.0 |
| Salt | | 2.0 | 2.0 | 2.0 |
| Sugar | 7.0 | | 8.0 | |
| Shortening | | | 4.0 | |

In Examples 3-6, a baked product was prepared according to the steps outlined in Example 2, except as follows:

| | | | | | | | Humid- |
|---|---|---|---|---|---|---|---|
| | | | | | | | ity |
| | | | | | | | (mL |
| | | Thaw | Proof | Bake | Fro- | | water/ |
| | Rest | Time/ | Time/ | Time/ | zen | Baked | L oven |
| | Time | Temp | Temp | Temp | S.V. | S.V. | capac- |
| Ex. | (min) | (min/F.) | (min/F.) | (min/F.) | (cc/g) | (cc/g) | ity) |
| 3* ** | 10 | 10/300 | 7/480 | | 1.23 | 2.5 | 1.1 |
| (pretzel) | | | | | | | |
| 4* | 30 | 9/356 | 6/383 | | 1.4 | 4.0 | 1.1 |
| (pizza) | | | | | | | |
| 5 | 20 | 13/250 | 8/350 | 5/375 | 1.4 | 5.0 | 1.1 |
| (soft | | | | | | | |
| roll) | | | | | | | |
| 6** | 30 | 12/275 | 14/400 | 11/350 | 1.14 | 4.0 | 1.74 |
| (bread) | | | | | | | |

*The pretzel and pizza examples did not have a separate proofing step.
**The bread and the pretzel were prepared in a Wiesheu oven.

While the present invention is described with respect to particular examples and preferred embodiments, it is understood that the present invention is not limited to these examples and embodiments. Additionally, the types of dough and baked products made from dough are not limited to the specific types listed herein. Other types of baked products discussed herein are within the scope of the present invention.

Moreover, the present invention is not limited to the processing steps recited herein and may contain additional steps, such as adding, mixing or baking steps, as would be apparent to those skilled in the art depending on what ingredients are used. Additionally, the present invention is not limited to the order of the processing steps. For example, ingredients may be added to one another in a different order than those set forth herein.

The present invention as claimed therefore includes variations from the particular examples and preferred embodiments described herein, as will be apparent to one of skill in the art.

What is claimed is:

1. A non-laminated frozen dough comprising:
flour, water, yeast and dough conditioner;
wherein the dough is rested before being frozen;
wherein the dough has a specific volume of 1.5 or less; and
wherein the dough is capable of achieving an industry-acceptable baked specific volume.

2. The frozen dough of claim 1, wherein the dough contains up to 16% protein by weight of the flour.

3. The frozen dough of claim 1, wherein the dough is capable of achieving a baked specific volume of about 4 cc/g or more.

4. The frozen dough of claim 1, wherein the frozen dough includes one or more ingredients selected from the group consisting of DATEM, potassium iodate, azodicarbonamide, potassium bromate, ascorbic acid, sodium stearoyl lactylate, calcium stearoyl lactylate, lecithin and monoglycerides, diglycerides, and L-cysteine.

5. The frozen dough of claim 1, wherein the frozen dough contains substantially no chemical leavener.

6. The frozen dough of claim 1, wherein the frozen dough contains substantially no melting point depressant and substantially no fermentation aid.

7. The frozen dough of claim 1, wherein the frozen dough is rested for about 10 to 60 minutes before being frozen.

8. The frozen dough of claim 1, wherein the frozen dough is rested for about 15 to about 30 minutes before being frozen.

9. A method for preparing a non-laminated frozen dough comprising:
mixing ingredients comprising flour, water, yeast and dough conditioner to form dough;
resting the dough; and
freezing the dough;
wherein the frozen dough has a specific volume of 1.5 or less; and wherein the frozen dough is capable of achieving an industry-acceptable baked specific volume.

10. The method of claim 9, wherein the dough is rested for about 10 minutes or more.

11. The method of claim 9, wherein the frozen dough contains less than 16% protein.

12. The method of claim 9, wherein the mixing step takes place at a dough temperature of about 55° F. to about 80° F.

13. The method of claim 9, wherein the dough is capable of achieving a baked specific volume of about 4 cc/g or more.

14. Frozen dough made by the method of claim 9.

15. A method for preparing a baked product comprising:
thawing non-laminated frozen dough at a first temperature and a first humidity for a time sufficient to thaw the dough;
proofing the dough at a second temperature and second humidity for a time sufficient to proof the dough; and
baking the dough at a third temperature for a time sufficient to bake the dough;
wherein the frozen dough comprises
flour, water, yeast and dough conditioner;
wherein the dough is rested before being frozen;
wherein the dough has a specific volume of 1.5 or less; and
wherein the dough is capable of achieving an industry-acceptable baked specific volume.

16. The method of claim 15, wherein the thawing, proofing and baking steps are performed in an oven that automatically controls temperature.

17. The method of claim 15, wherein the dough contains less than 16% protein.

18. The method of claim 15, wherein the dough is capable of achieving a baked specific volume of about 4 cc/g or more.

19. A method for preparing a baked product comprising:
preparing non-laminated frozen dough by a process comprising the following steps:
mixing ingredients including flour, water, yeast and dough conditioner to form dough;
resting the dough; and
freezing the dough;
thawing the frozen dough at a first temperature and humidity sufficient to thaw the dough;
proofing the dough at a second temperature and second humidity sufficient to proof the dough; and
baking the dough at a third temperature sufficient to bake the dough;
wherein the dough has a specific volume of 1.5 or less before being frozen; and
wherein the dough is capable of achieving an industry-acceptable baked specific volume.

20. A baked product produced by the method of claim 19.
